(19) United States
(12) Patent Application Publication
(10) Pub. No.: US 2006/0239206 A1
(43) Pub. Date: Oct. 26, 2006

(54) APPARATUS AND METHOD FOR NETWORK IDENTIFICATION AMONG MULTIPLE APPLICATIONS

(75) Inventors: Ravi T. Rao, Redmond, WA (US); Rohit Gupta, Redmond, WA (US); Tomer Weisberg, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 10/907,982

(22) Filed: Apr. 22, 2005

(51) Int. Cl. H04L 12/28; H04L 12/56

(52) U.S. Cl. 370/254; 370/409

(57) ABSTRACT

A method of identification used for communication within a network includes generating a network identity associated with a user, modifying the network identity according to a user preference to create a modified network identity, identifying the user with the modified network identity within a first network communication for a first network communication application, and identifying the user with the modified network identity within a second network communication for a second network communication application.

### BACKGROUND

Network communication technologies on the Internet allow users with common interests to collaborate, share files, chat with one another, multi-cast audio and video for presentations and group meetings, and engage in multi-player gaming. A user's computer may include multiple applications for engaging in these network communications. Currently, however, most network communication and formation takes place in a server-centric environment whereby all communication flows to or through large central servers to which individuals may connect to join and participate in the group. Peer-to-peer technologies enable users to contact one another in a serverless environment, free from the constraints of server-based Internet communication. Whether the network communication is server-centric or peer-to-peer, each application creates its own account which includes a network identification to uniquely identify the user to the peer client or to the server. In a server-centric environment, the account is backed by a server which authenticates the user, and provides assurances of authentication to other clients communicating through the server. In a peer-to-peer environment, the peer client communicates with the user based on a mutual trust, and peer-to-peer identities are used to identify the user. However, this results in numerous different network identifications being used to identify the same user, because each application uses a different network identification.

In a peer-to-peer or server-centric environment, a user may want to be able to choose a network identification to identify the user in network communications, and personalize that identification according to the user's preferences. Currently, however, network identifications created by the applications are not intuitive to the typical user, which creates difficulties for a typical user to identify and use a particular network identification for a particular application.

### SUMMARY

A method of identification used for communication within a network is disclosed. The method may include generating a network identity associated with a user, modifying the network identity according to a user preference to create a modified network identity, identifying the user with the modified network identity within a first network communication for a first network communication application, and identifying the user with the modified network identity within a second network communication for a second network communication application.

A computer readable medium with computer instructions to execute a method of identifying a user in peer-to-peer network communications is disclosed. The computer readable medium may include computer executable instructions for generating a default network identity uniquely associated with a user, for establishing peer-to-peer network communication with one or more peer clients, for executing a plurality of network communication applications adapted to communicate with the one or more peer clients, and for associating the default network identity with each of the plurality of network communication applications to identify the user to the one or more peer clients.

A computer system with a display unit that is capable of generating video images, an input device, a processing apparatus operatively coupled to said display unit and said input device, and a network interface connected to a network and to the processing apparatus is disclosed. The processing apparatus may include a processor and a memory operatively coupled to the processor. The processing apparatus may be programmed to generate a network identity associated with a user, to modify the network identity according to a user preference to create a modified network identity and to associate the modified network identity with a plurality of network communication accounts. Each network communication account may be associated with a network communication application.

### DRAWINGS

FIG. 1 is a block diagram of a computing system that may operate in accordance with the claims;

FIG. 2 illustrates a general flowchart for creating a network identification in an embodiment of the claims; and

FIG. 3 illustrates a general flowchart for utilizing the network identification for multiple network communication applications in an embodiment of the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘ - - - ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

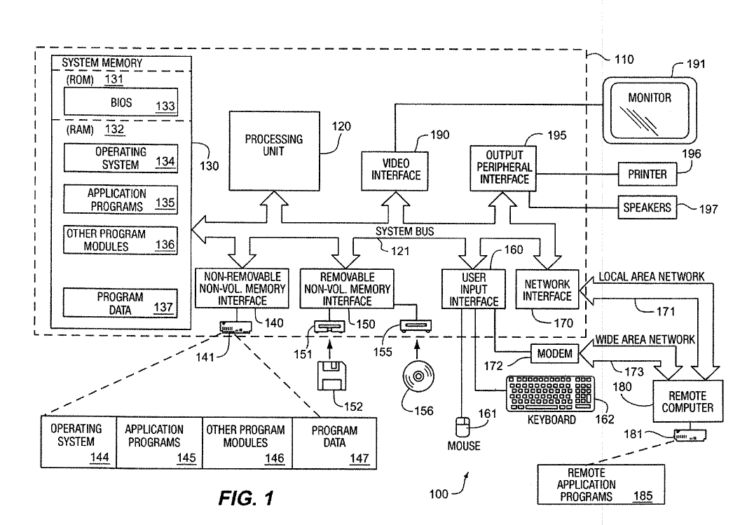

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 1 30, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 1 33 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

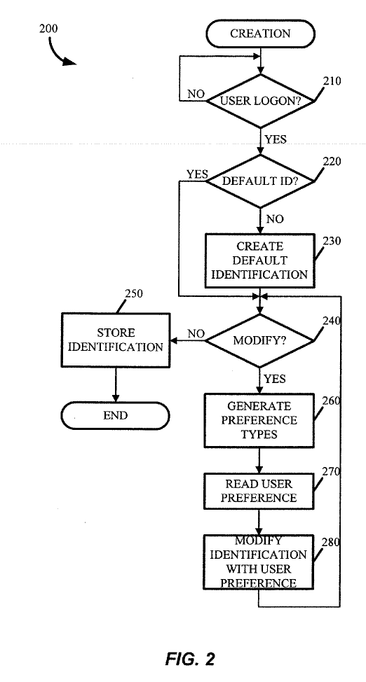

FIG. 2 is an illustration of a method 200 of creating a user identification for use by multiple applications in network communications. The method 200 may be utilized to locally generate a default network identity associated with a user. In one example, the method 200 may be implemented in an identity manager. An example of an identity manager is disclosed in U.S. Patent Publication No. 2004/0111515 filed Dec. 4, 2002, the contents of which are expressly incorporated by reference herein. Although described herein as a user identification, it should be understood that the network identity may refer to one of multiple users that may use a particular computer 110 or workstation. Alternatively, the user identification may refer to the computer 110 or workstation itself, or may refer to a group of users. The method 200 may further be used to modify the default network identity according to one or more user preferences. The network identity may be used by multiple applications when communicating in a network communication, as described more fully below. The method 200 thereby allows a user to create a personalized identity for use by multiple applications engaging in network communications.

The method 200 may create a default network identification using a variety of triggers. For example, at block 210, the method 200 may detect the user logging on to the computer 110. The determination at block 210 may be based on a user entering a user name and/or password, or activating the computer 110. Once a user has activated or logged on to the computer 110, the method 200 may determine whether a default user identification is associated with the user by searching among a list of network identities. The list of network identities may be maintained by an identity manager application, such as the identity manager disclosed in U.S. Patent Publication No. 2004/0111515 filed Dec. 4, 2002, referred to above. Although the method 200 may check for a default network identification each time a user activates or logs on to the computer, the method 200 may check for a default network identification associated with the user in a variety of circumstances, such as, but not limited to, creating a new user account, establishing a network or other remote connection, installation of a new network communication application, launching a network communication application or creating a new network account for a network communication application. If a default network identification exists, control may pass to block 240 where the user may be presented with the option of modifying the default network identification to create a personalized network identification according to the user's preferences.

If a default network identification associated with the user does not exist, as determined at block 220, the method 200 may create a new default network identification associated with the user at block 230. If a default network identification associated with the user already exists, control may pass to block 240. Generally, the default network identification may be a locally-created identification uniquely associated with the user. The default network identification may include a username, a public-private key pair, or other cryptographic key, and an identity certificate. Generally, the default network identification may be readily recognized by the username, which may be a generic identifier (e.g., “DEFAULT”), a local username of the user or a username specified by the user. In one example, the default network identification created at block 230 is a peer-to-peer network identity, though as described further below, the default network identification is not limited to peer-to-peer communications. In some cases, the user may already have network identification for existing user accounts and/or network communication applications, in which case a default network identification may still be created at block 230 to be associated with, and used by, all user accounts and application accounts. In the case of multiple users, multiple default network identifications may be created and stored. Because of the multiple user identifications for various accounts and/or various users, the default network identification may be readily identifiable from among the multiple identifications, such that the default identification is readily recognizable and distinguishable to a user and/or an application.

At block 240, the user may be presented with the option of modifying the default network identification with various user preferences. The presentation may include a display screen generated on the monitor 191 which prompts the user to make an input, such as a keystroke or mouse click, indicating the user's option. If a user makes an input to the computer 110 requesting modification as determined at block 240, a user preference display may be generated on the monitor 191 at block 260 to allow the player to select user preferences to modify the default network identification.

If the user make an input to the computer 110 indicating no modification, the default network identification may be stored at block 250. The default network identification may be stored locally in a memory 130 of the computer 110 or stored in a memory or database of a network server, such as a local area network server, operatively coupled to the computer 110. In one example, the default network identification may be stored with a list of network identifications in the identity manager application which may be used to manage the various network identifications that may exist for various network communication applications.

At block 260, the method 200 may present a variety of user preference options to the user by, for example, causing a preference selection display to be generated on the monitor 191. The preference selection display may include, for example, a list of various preference types that may be associated with the default network identification and/or a visual message to prompt the user to provide a modification to the default network identification. The types of preferences may be alphanumeric characters and/or images chosen by the user. For example, the user preference types may include, but are not limited to, an alphanumeric name, an email address, a telephone number, a picture, a video, a user avatar or any other custom user information. The user may select a preference type for modification, such as modifying a picture associated with the default network identification. The method 200 may then prompt the user to specify a picture to associate with the default network identification.

The user may upload the user preference to the memory 130 of the computer 110, or select a pre-loaded user preference stored in the memory 130, and the user preference may be read at block 270. In the case of preference types such as an alphanumeric name or email address, the user may input the name or email address via the keyboard 162, the mouse 161 or other input device. For preference types such as a picture, video or avatar, the user may specify the appropriate file as stored in a local, remote or removal storage medium. In one example, the user's preferences may be pre-loaded in the memory 130 of the computer 110, and the method 200 may automatically read the appropriate file(s) containing the user preferences and associate them with the default network identification when the default network identification is first created. The method 200 may further be used to modify an existing default network identification with additional or different user preferences, if a pre-existing default network identification is found at block 220.

At block 280, the method 200 may modify the default network identification with the user preference read at block 270. The modification at block 280 may refer to associating the user preference read at block 270 with the default network identification. In effect, the default network identification may be modified with the user preferences by attaching or associating the user preference with the default network identification, and the default network identification itself may remain unchanged. For example, the default network identification created at block 230 may be recognized as “DEFAULT” by the various applications. Although various user preferences may be associated with default network identification, the various applications may continue to recognize the default network identification as “DEFAULT” regardless of the user preferences. However, it should be understood that the modifications implemented at block 280 may be extended to the default network identification itself with a corresponding update provided to all applications to recognize the newly modified default network identification. For example, the default network identification created at block 230 may initially be recognized as “DEFAULT” by the various applications. A modification of the default network identification itself, such as a user email address, may change the default network identification from “DEFAULT” to “user@domainname.com”.

In addition to modifying the default network identification at the user's computer at block 280, the default network identification may be updated with respect to the user's contacts. For example, the user may maintain a list of contacts (e.g., other persons, organizations, computers, etc.) in a memory of the computer 110 and provide the default network identification to those contacts. Once the default network identification is modified, the method 200 may automatically provide the modified default network identification to each of the contact, or to those contacts previously identified by the user such as those contacts who received the default network identification as previously shared by the user). The modified default network identification may be published for viewing by the contacts, sent via electronic mail to the contacts and/or seamlessly updated in a contact list maintained by each of the contacts. In yet another example, other users in proximity to the user (e.g., in the same home, office, network etc.) may be capable of viewing the default network identification, and any modifications thereof, without being explicitly listed in a contact list.

Having implemented the modifications at block 280, control may pass back to block 240 where the user may implement another user preference. If no further modifications are desired, as determined at block 240, the modified default network identification may be stored in a memory of the computer 110 at block 250, and the method 200 may terminate. The user may thereby personalize the default network identification with attributes chosen by the user that may further allow the user to readily identify the default network identification from among multiple network identifications.

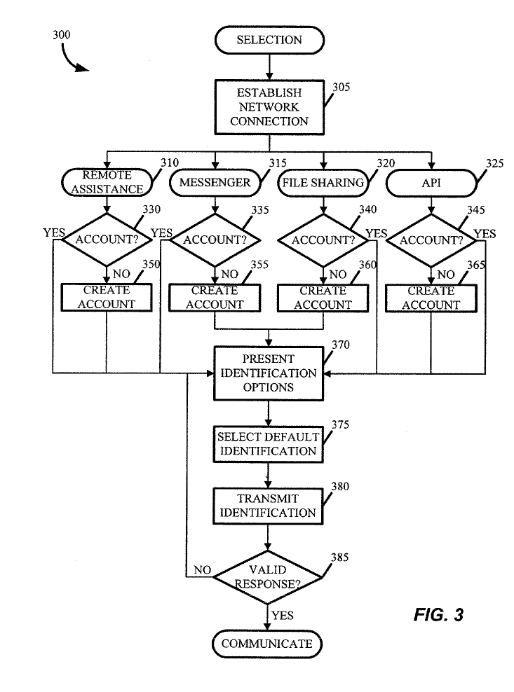

FIG. 3 is an example of a method 300 illustrating the use of a default network identification, whether modified or unmodified, by multiple network communication applications. For example, having stored the default network identification in a memory of the computer 110, authentication and authorization mechanisms, such as a secure channel (SChannel), secure sockets layer (SSL), and transport layer security protocol (TSL), may use the default network identification for security purposes. Network communication applications, such as internet browsers, messengers, etc., may seamlessly use the default network identification for securing connections. An authentication and/or authorization process may utilize the default network identification to indicate the authenticity and/or authority of the user during network communications. For example, in a peer-to-peer communication, the default network identification may be provided to another peer client and accepted as an authenticated and/or authorized user. Likewise, in internet transactions, the default network identification may be provided to indicate the user is authentic and authorized to complete the transaction.

Although each network communication application may have its own account and a corresponding network identification for network communications, the method 200 provides the user with the option of using the default network identification for all network communication applications. Although described primarily as peer-to-peer network communication applications, the applications may also include server-based applications. Further, while described primarily as a peer-to-peer network communication with a peer client, it should also be understood that the network communication may be server-centric where the network communication is with a client via a server.

At block 305, a peer-to-peer network connection may be established. The network communication may be initiated by the user, or may be initiated by a network communication application when the user launches the application. A network communication may be established for each network communication application, and each network communication may be with a different peer client. The network connection(s) may be established using known protocols that will not be described further herein.

The various network communication applications that may utilize the default network identification may include, but are not limited to, a remote assistance routine 310, a messenger application 315, a file sharing application 320 and an application program interface 325. The remote assistance routine 310 may be used to provide remote technical assistance via the network from a peer client. The messenger application 315 may be used for general correspondence with a peer client. The file sharing application 320 may be used to send and receive data files with a peer client. The application program interface 325 may be used to interface communications between a peer client and another application executed locally on the computer 110. With each network communication application 310, 315, 320, 325, the responding peer client may request or otherwise require a network identification to verify the authenticity and identity of the user prior to further communications with the user. Each of the network communication applications 310, 315, 320, 325 may be executed simultaneously or individually, though the default network identification may be used for each of the network communication applications 310, 315, 320, 325, as described further below.

At blocks 330, 335, 340, 345, the method 300 may determine whether the network communication application 310, 315, 320, 325 has an account for communicating with the peer client. Each network communication application 310, 315, 320, 325 may include at least one account and an associated network identification for communicating with peer clients. In some cases, each network communication application 310, 315, 320, 325 may have multiple accounts and associated network identifications, with a dedicated account and network identification for each peer client. Each account may relate to a prior authentication process that was established with the peer client to verify the user's identity and authenticity. Each network identification may be a public-private key pair that uniquely identifies the user to the peer client as an authenticated user and which is exclusively associated with the network communication application or an account thereof. That is, the network identification is not used by other network communication applications. Each network identification may be stored in the identity manager application along with the default network identification.

The determination at blocks 330, 335, 340, 345 may be made separately for each of the network communication applications 310, 315, 320, 325, such that those with accounts may continue with the communication session and those without accounts may have an account created before proceeding further. If an account has been previously created, control may pass to block 370. The account may be previously created from installation of the network communication application 310, 315, 320, 325, from a prior execution of the network communication application 310, 315, 320, 325 or from a prior network communication with the peer client. If an account does not exist, as determined at blocks 330, 335, 340, 345, control may pass to blocks 350, 355, 360, 365 respectively.

At blocks 350, 355, 360, 365 the method 300 may create a new account for each of the network communication applications 310, 315, 320, 325 that do not have an existing account. The account creation may include a verification and authentication process between the network communication application 310, 315, 320, 325 and the peer client, resulting in an exchange of public-private key pairs. As part of creating a new account, a network identification may be created for the particular network communication application 310, 315, 320, 325 to uniquely identify the user to the peer client. Any network identifications created at blocks 350, 355, 360, 365 may be stored with the identity manager application. While each of the accounts created at blocks 350, 355, 360, 365 may result in an associated network identification to uniquely identify the user, such network identifications may be exclusively associated with the newly created account and/or the respective network communication application 310, 315, 320, 325. The network identities created at blocks 350, 355, 360, 365 are not shared among the network communication applications 310, 315, 320, 325. By comparison, the default network identification may be associated with any and all of the newly created account at blocks 350, 355, 360, 365 and may be provided to the peer client as an authenticated identity of the user for future network communications. Once the account has been created and the default network identification associated with the newly created account, control may pass to block 370.

At block 370, a variety of network identification options may be presented as a list of network identifications read from the identity manager. The list may be presented to the user as a display screen generated on the monitor 191. Alternatively, the list may be presented to the applications 310, 315, 320, 325, rather than the user, to facilitate an automatic selection of the default network identification that is transparent to the user. The presented list may include the default network identification along with one or more of the various network identifications associated with each network communication account and/or network communication application 310, 315, 320, 325. The presented list may include all network identifications stored in the identity manager, or may include only a subset of the stored network identifications, such as the default network identification and those associated with the network communication applications 310, 315, 320, 325 (or account thereof) being used at that time. Generally, any list presented at block 370 includes the default network identification. In one example, the method 300 may provide only the default network identification at block 370 regardless of the existence of other associated network identifications, including those created at blocks 350, 355, 360, 365 to force the utilization of the default network identification. It should also be understood that multiple default network identifications may be stored by the identity manager application and may be presented at block 370. Multiple default network identifications may refer to multiple users and/or multiple default network identifications of a single user.

At block 375, the user may select the default network identification from among the list of network identifications, thereby presenting the user with the option of using the default network identification for the network communication or using another network identification exclusively associated with a particular network communication application. Alternatively, the network communication application(s) 310, 315, 320, 325 may automatically select the default network identification from among the list of network identifications. For example, each of the various network communication applications 310, 315, 320, 325 may take in a “null” value to imply that the default network identification should be used, as opposed to other associated network identifications. In the case of presenting only the default network identification at block 370 the user or the network communication application(s) 310, 315, 320, 325 may be forced to use only the default network identification. Regardless of the selection process at block 375, the same default network identification may be used by multiple network communication applications 310, 315, 320, 325 for multiple network communications.

At block 380, the network communication application(s) 310, 315, 320, 325 may transmit the default network identification (or other chosen network identification) to the peer client. The peer client may return a response, which may be detected at block 385. The response from the peer client may indicate acceptance of default network identification or a rejection. If the peer client rejects the default network identification or if the peer client does not provide a response, the method 200 may retransmit the default network identification or revert back to block 370 to request the user or the network communication application 310, 315, 320, 325 to select a different network identification. If the peer client provides a response indicating acceptance of the default network identification as uniquely identifying the user, the network communication application may engage in further network communications with the peer client. As a result, two or more network communication applications may use the default network identification to uniquely identify the user in a network communication, rather than using different network identifications for each application. The method 300 may provide the user with the option of using the default network identification for any network communication application 310, 315, 320, 325, in which case the default network identification is readily distinguishable from the other network identifications based on the creation method 200. While the various network communication applications 310, 315, 320, 325 may still create their own respective network identifications, each network communication application 310, 315, 320, 325 also recognizes the default network identification for identifying the user in any network communication.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed as new and desired to be protected by Letters Patent of the United States is:

1. A method of identification used for communication within a network comprising:
generating a network identity associated with a user;
modifying the network identity according to a user preference to create a modified network identity; and
identifying the user with the modified network identity within a first network communication for a first network communication application; and
identifying the user with the modified network identity within a second network communication for a second network communication application.

2. The method of claim 1, wherein generating the network identity comprises:
searching for an existing network identity associated with a user; and
generating the network identity if an existing network identify associated with a user is not found.

3. The method of claim 1, wherein generating the network identity comprises one or more of the group consisting of generating the network identity when the user initiates interaction with the computer, generating the network identity when the user establishes a network connection and generating the network identity when the user launches a network communication application.

4. The method of claim 1, wherein modifying the network identity according to a user preference comprises modifying the network identity with one or more of the group consisting of: an alphanumeric name associated with the user, an email address associated with the user, a telephone number associated with the user and an image associated with the user.

5. The method of claim 1, further comprising:
creating a first network communication account for the first network communication application;
creating a second network communication account for the second network communication application; and
associating the modified network identity with the first and second network communication accounts.

6. The method of claim 1, further comprising:
automatically selecting the modified network identity from among a plurality of network identities, wherein the plurality of network identities comprise the modified network identify, a first network identity exclusively associated with the first network communication application and a second network identity exclusively associated with the second network communication application; and
automatically associating the modified network identify with the first and second network communication applications.

7. The method of claim 1, further comprising:
presenting the user with a plurality of network identities, wherein the plurality of network identities comprise the modified network identity, a first network identity exclusively associated with the first network communication application and a second network identity exclusively associated with the second network communication application;
receiving data relating to a selection of the modified network identity; and
associating the modified network identify with the first and second network communication applications.

8. The method of claim 1, wherein one or more of the first and second network communications comprises one of the group consisting of: a peer-to-peer network communication and a server-based network communication.

9. A computer readable medium having computer executable instructions for performing a method of identifying a user in peer-to-peer network communications comprising:
computer executable instructions for generating a default network identity uniquely associated with a user;
computer executable instructions for establishing peer-to-peer network communication with one or more peer clients;
computer executable instructions for executing a plurality of network communication applications adapted to communicate with the one or more peer clients; and
computer executable instructions for associating the default network identity with each of the plurality of network communication applications to identify the user to the one or more peer clients.

10. The computer readable medium of claim 9, further comprising computer executable instructions for modifying the network identity according to a user preference to create a modified network identity.

11. The computer readable medium of claim 10, wherein the computer executable instructions for modifying the network identity according to a user preference comprise computer executable instructions for modifying the network identity with one or more of the group consisting of: an alphanumeric name associated with the user, an email address associated with the user, a telephone number associated with the user and an image associated with the user.

12. The computer readable medium of claim 9, further comprising computer executable instructions for automatically selecting the default network identity from among a plurality of network identities, wherein the plurality of network identities comprise the default network identity and at least one network identity exclusively associated with one of the network communication applications.

13. The computer readable medium of claim 9, further comprising computer executable instructions for allowing the user to select the default network identity from among a plurality of network identities, wherein the plurality of network identities comprise the default network identity and at least one network identity exclusively associated with one of the network communication applications.

14. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
the processing apparatus being programmed to generate a network identity associated with a user;
the processing apparatus being programmed to modify the network identity according to a user preference to create a modified network identity; and
the processing apparatus being programmed to associate the modified network identity with a plurality of network communication accounts, wherein each network communication account is associated with a network communication application.

15. The computing apparatus of claim 14, wherein the processing apparatus is programmed to create the network identity during one or more of the group consisting of: the user establishing a network connection, the user initiating interaction with a networking enabled computer and the user launching a network communication application.

16. The computing apparatus of claim 14, further comprising:
the processing apparatus being programmed to search for an existing network identity associated with a user; and
the processing apparatus being programmed to generate the network identity if an existing network identify associated with a user is not found.

17. The computing apparatus of claim 14, wherein the processing apparatus is programmed to modify the network identity with one or more of the group consisting of: an alphanumeric name associated with the user, an email address associated with the user, a telephone number associated with the user and an image associated with the user.

18. The computing apparatus of claim 14, further comprising the processing apparatus being programmed to automatically select the modified network identity from among a plurality of network identities, wherein the plurality of network identities comprise the modified network identify and at least one network identity exclusively associated with one of the network communication applications.

19. The computing apparatus of claim 14, further comprising the processing apparatus being programmed to allow the user to select the modified network identity from among a plurality of network identities, wherein the plurality of network identities comprise the modified network identity and at least one network identity exclusively associated with one of the network communication applications

20. The computing apparatus of claim 14, wherein at least one of the one or more network communications comprises one of the group consisting of: a peer-to-peer network communication and a server-based network communication.
